(19) United States
(12) Patent Application Publication
(10) Pub. No.: US 2015/0158376 A1
(43) Pub. Date: Jun. 11, 2015

(54) Air Flap Device

(71) Applicant: Röchling Automotive SE & Co. KG, Mannheim (DE)

(72) Inventors: Thomas Ehrenberg, Lorsch (DE); Domenico Solazzo, Worms (DE); Micro Brusco, Leifers (IT); Walter Kral, Sarntal (IT); Ludwig Huber, Durbach (DE)

(73) Assignee: Röchling Automotive SE & Co. KG, Mannheim (DE)

(21) Appl. No.: 14/566,332

(22) Filed: Dec. 10, 2014

(30) Foreign Application Priority Data
Dec. 11, 2013 (DE) 10 2013 225 610.8

(51) Int. Cl. B60K 11/08

(52) U.S. Cl. CPC B60K 11/085

(57) ABSTRACT

An air flap device, preferably for use in motor vehicles, comprising a housing that defines a flow passage opening, at least one air flap that is accommodated movable on the housing such that by adjusting the air flap relative to the housing the effective flow cross-section of the flow passage opening can be changed, a heat source arranged in the air-flow direction behind the at least one air flap, an energy source that is separate from the heat source, and at least one controllable flap actuator that can be controlled by a control unit (20) which has an energizing connection to the separate energy source, for adjusting an air flap relative to the housing. In this context, at least one automatic flap actuator is also provided, which is supplied with thermal energy provided directly by the heat source for adjusting an air flap relative to the housing.

### CROSS REFERENCE TO RELATED APPLICATIONS)

This application claims priority to German Application No. 10 2013 225 610.8, filed Dec. 11, 2013. The entirety of the disclosure of the above-referenced application is incorporated herein by reference.

### BACKGROUND OF THE INVENTION

1. Field of the Invention

The present invention relates to an air flap device, preferably for use in a motor vehicle, comprising a housing that defines a flow passage opening, at least one air flap that is accommodated movable on the housing such that by adjusting the air flap relative to the housing the effective flow cross-section of the flow passage opening can be changed, a heat source arranged behind the at least one air flap in the direction of the air flow, an energy sources separate from the heat source, and at least one controllable flap actuator that can be controlled by a control unit which has an energizing connection to the energy source in order to adjust an air flap relative to the housing.

2. Description of the Related Art

In air flap devices of this kind, an air flap is adjusted relative to the housing by means of a controllable flap actuator in accordance with certain operational parameters from the control unit. As a result of this, the amount of fresh air flowing to the heat source arranged behind the air flap for a convective cooling of said heat source is changed. Thus, the temperature of the heat source can be regulated, or at least selectively influenced by changing the amount of fresh air. In the event that a malfunction of the air flap device occurs, for example due to a fault of the controllable flap actuator or of the control unit, a sufficient supply of fresh air, and thus sufficient convective cooling of the heat source can, however, no longer be guaranteed, if the effective flow cross-section of the flow passage opening is too small. In consequence, there is a risk for the heat source to overheat.

It is therefore the object of the present invention to provide an air flap device with which the supply of an amount of fresh air that is sufficient for a convective cooling of the heat source can be guaranteed.

### SUMMARY OF THE INVENTION

According to the present invention, this object is attained by means of an air flap device as described above, wherein, in addition, at least one automatic flap actuator is provided, which is supplied with thermal energy provided directly by the heat source for the purpose of adjusting an air flap relative to the housing.

As the automatic flap actuator is designed for adjusting an air flap relative to the housing, it can change the effective flow cross-section of the flow passage opening in the same way as a controllable flap actuator, and thus also change the amount of fresh air supplied to the heat source. For this purpose, the automatic flap actuator is supplied with thermal energy provided directly by the heat source and can therefore function independently of separate sources of energy, such as a motor vehicle battery, or an electric generator, or an electric controller. Furthermore, it can be ensured that precisely when sufficient convective cooling of the heat source cannot be guaranteed by the controllable flap actuator due to a malfunction, and the temperature of the heat source, and thus also the amount of thermal energy given off by said heat source per time unit increases, sufficient energy can be supplied to the automatic flap actuator, precisely because of this temperature increase, in order to adjust an air flap. In this way, it can be achieved that, for example, in the event of a malfunction of the controllable flap actuator a sufficient amount of fresh air can be supplied to the heat source by means of an adjustment of an air flap via the automatic flap actuator.

What is preferably meant as a source of heat consistent with this invention is an energy source that outputs heat as a primary form of energy, such as, for example, a coolant-heat exchanger or an internal combustion engine, an air-conditioning system, or a lubrication circuit. It can, in principle, also be assumed that the separate source of energy, which can, for example, be designed as a motor vehicle battery or a dynamo, will heat up during operation and thus output energy in the form of heat. Heat is, however, not the primary form of energy of this source of energy because the amount of energy output per time unit in the form of electrical energy is several orders of magnitude larger than the amount of energy output in the form of heat per time unit. Even though it should not be ruled out that the separate source of energy for actuating the controllable flap actuator also supplies heat, it is preferred, for the purpose of an efficient supply of energy, that the separate source of energy for actuating the controllable flap actuator supplies a kind of energy other than heat, such as electrical, mechanical, electromagnetic, hydraulic, or pneumatic energy.

What is meant by air flap actuator in teams of the present invention is an actuator provided with a force output part, which is connected, or can be connected, to an air flap so as to transfer force and movement.

In order to provide an air flap device that is as compact as possible, it can be provided in further developments of the invention that at least one automatic flap actuator can be additionally controlled by the control unit. A flap actuator of this kind can, for example, comprise a bimetallic strip. A bimetallic strip comprises at least two metal strips that are permanently fixed to each other, which have different thermal expansion coefficients. In that way, a change in temperature results at different degrees of expansion or contraction of the respective strips, and thus in a deformation, for example, a curvature of the bimetallic strip, which can be utilized for the adjustment of an air flap. According to this further development, it is not necessary to provide two or a plurality of separate flap actuators, which allows for a compact and space-saving design.

Furthermore, the control unit can control the controllable flap actuator in accordance with the temperature of the heat source as detected by a temperature sensor. As a result of this, at least one air flap can be adjusted according to the detected temperature of the heat source, such that when a temperature is detected which is higher than a set-point temperature, the effective flow cross-section of the flow passage opening is enlarged, whereby a cooling effect can be achieved. If, however, the detected temperature is below a set-point temperature, the at least one air flap can be adjusted such that the effective flow cross-section of the flow passage opening is reduced, whereby the cooling effect caused by inflowing air is reduced. As a result of this, the temperature of the heat source can also be selectively influenced.

Furthermore, it can be provided that at least one controllable flap actuator with at least one automatic flap actuator can be connected in series and/or that at least one controllable flap actuator is connected in parallel to at least one automatic flap actuator.

If the automatic flap actuator and the controllable flap actuator are connected in series, only the force output part of an actuator consisting of the controllable flap actuator and of the automatic flap actuator can be connected to, or brought in connection with, the air flap to be adjusted such that force and movement are transferred, whereas the force output part of the respectively other actuator consisting of the controllable flap actuator and of the automatic flap actuator can be connected to, or can be brought in connection with the one actuator, so as to transmit force and movement. In this context, the flap actuator, whose power output part directly causes an air flap adjustment, is preferably mounted movable, preferably displaceable, relative to the housing, whereas the respective other flap actuator for the selective force and movement output, is stationary, with the exception of its power output part, relative to the housing. Thus, the flap actuator that is directly coupled to the air flap is indirectly supported on the respective other flap actuator when in operation and, in this way, is indirectly supported on the housing via the latter. The respective other flap actuator is, on the other hand, directly supported on the housing and indirectly coupled, to the air flap via the one flap actuator. During its actuating operation, the respective other flap actuator, as a rule, jointly moves the one flap actuator and the air flap. Due to the small masses that are moved, the controllable flap actuator, which, as a rule, is operated more often, is preferably directly coupled to the air flap.

If, on the other hand, the automatic flap actuator and the controllable flap actuator are connected in parallel, the force output parts of the controllable flap actuator and of the automatic flap actuator can each be connected, preferably to one and the same air flap to be adjusted, such that force and movement are transmitted, or brought in connection with said air flap for a corresponding adjustment. In order to avoid unnecessarily large actuating forces this solution preferably provides a coupling configuration which is configured to separate the coupling of a flap actuator with an air flap, if the respective other flap actuator is actuated for the transmission of force with the air flap.

Irrespective of whether an automatic flap actuator and a controllable flap actuator are connected in series or in parallel, it can be ensured according to this further development of the invention that in the event of a malfunction of the controllable flap actuator, the air flap will be adjusted by the automatic flap actuator.

Furthermore, at least one automatic flap actuator can have an actuator section that is configured such that it deforms when heated and/or undergoes a phase transition, preferably a solid-liquid phase transition. Automatic flap actuators configured in this way in general feature a very simple design and function reliably. For example, the automatic flap actuator can comprise a bimetallic strip or a wax expansion element. At a certain temperature, the latter undergoes a solid-liquid phase transition increasing its volume, and in the course of this volume increase, can exert a corresponding force on the corresponding force output part. Likewise, a flap actuator with an actuator section can be provided, which at a certain temperature undergoes a liquid-gas phase transition. The deformation and/or phase transition are preferably reversible, which will allow a repeated use of the automatic flap actuator.

In a further development of the invention, it can be provided that at least one automatic flap actuator is configured so as to cause an air flap adjustment only when a limit temperature has been reached. In this way, it can be ensured that the automatic flap actuator is not activated by any temperature increase when the controllable flap actuator is functioning because this could impair the control of the controllable flap actuator by the control unit, since any additional air flap adjustment via the automatic flap actuator would have to be taken into account when controlling the controllable flap actuator. This ultimately means that the automatic flap actuator preferably only functions as an emergency flap actuator; that is, it is only activated once a limit temperature has been reached, which, in general, is only reached in case of a malfunction.

The heat source comprise motor vehicle engine and/or a fluid heat exchanger. A motor vehicle engine and a fluid heat exchanger are, in general, the heat sources in the engine compartment of a vehicle with the highest heat output levels. As a result of this, the automatic flap actuator can be supplied with sufficient thermal energy to reliably cause an air flap adjustment in the event of a malfunction.

In this context, thermal energy from the heat source can be transferred via thermal conduction and/or thermal radiation to the at least one automatic flap actuator. If the automatic flap actuator is mounted directly on the heat source, the thermal energy is mainly transferred via heat conduction. This allows a particularly efficient energy transfer from the heat source to the automatic flap actuator. On the other hand, a transfer of thermal energy from the heat source to the automatic flap actuator primarily by means of thermal radiation allows a greater flexibility with regard to the place of installation of the automatic flap actuator because the latter no longer necessarily has to be in physical contact with the heat source. It should, however, be pointed out that in case of a direct contact between the heat source and an automatic flap actuator, the thermal energy is also transferred via thermal radiation, but in such a case, the heat is predominantly transferred via thermal conduction.

A further development of the invention can provide that at least one controllable flap actuator is configured such that in the event of a malfunction, an error message is sent to the control unit. According to the present invention, by means of the automatic flap actuator, a sufficient amount of fresh air can be supplied to the heat source even in an emergency involving a malfunction of the controllable flap actuator. This amount can, however, under certain circumstances, deviate from an optimum amount of fresh air that corresponds to the operating conditions of a motor vehicle. If, on the other hand, in the event of a malfunction, an error message is sent to the control unit, a malfunction, for example of the automatic flap actuator or of the control unit, can be quickly recognized and remedied, in turn resulting in that an optimum functionality of the air flap device, and thus of the motor vehicle, can be quickly restored.

In order to ensure an as compact a design as possible, it can be provided that a plurality of lamella-like air flaps are provided, the area of a single air flap being smaller than the total area of the flow passage opening. The result of the fact that the lamella-like air flaps each have an area that is smaller than the entire area of the flow passage opening is that the free space that is required for the adjustment of the air flap, for example, in the engine compartment of a motor vehicle, is smaller than when a single air flap, whose area corresponds to the entire area of the flow passage opening, is used. The at least one air flap is preferably accommodated swivelable around a flap axis on the housing.

In order to avoid having to provide a flap actuator for each individual air flap, it can be provided that at least some of the air flaps are coupled via a coupling element for a mutual adjustment movement. As a result of this, a single flap actuator can thus be provided for the adjustment of a plurality of air flaps that are coupled to each other, which allows a compact design.

In order to at least facilitate a return of the corresponding air flap to its closing position after an air flap adjustment by means of which the effective flow cross-section of the flow passage opening is enlarged, it can also be provided that at least one air flap comprises a pretension element, which pretensions the air flap in the direction of its closing position. A pretension element of this type can, for example, be configured as a spring, in particular a spiral spring, and it is particularly practical when an automatic flap actuator and/or a controllable flap actuator is not continuously connected to a flap to be actuated, or is only connected to a flap to be actuated while transferring force in one direction. In such an instance, the air flap is adjusted under the effect of a flap actuator in order to enlarge the effective flow cross-section of the flow passage opening, whereas it can return to its closing position under the effect of the pretension element.

### BRIEF DESCRIPTION OF THE DRAWING FIGURES

The present invention will be described in more detail below with reference to the attached figures, which show:

FIG. 1 a schematic drawing of an inventive air flap device according to a first embodiment, with an automatic flap actuator that is connected in series to a controllable flap actuator,

FIG. 2 a partial section of an air flap device according to a second embodiment with an automatic flap actuator that is connected in parallel to a controllable flap actuator, and

FIG. 3 a top view from the direction III in FIG. 2 on the partial section shown in FIG. 2.

### DETAILED DESCRIPTION OF THE PREFERRED EMBODIMENTS

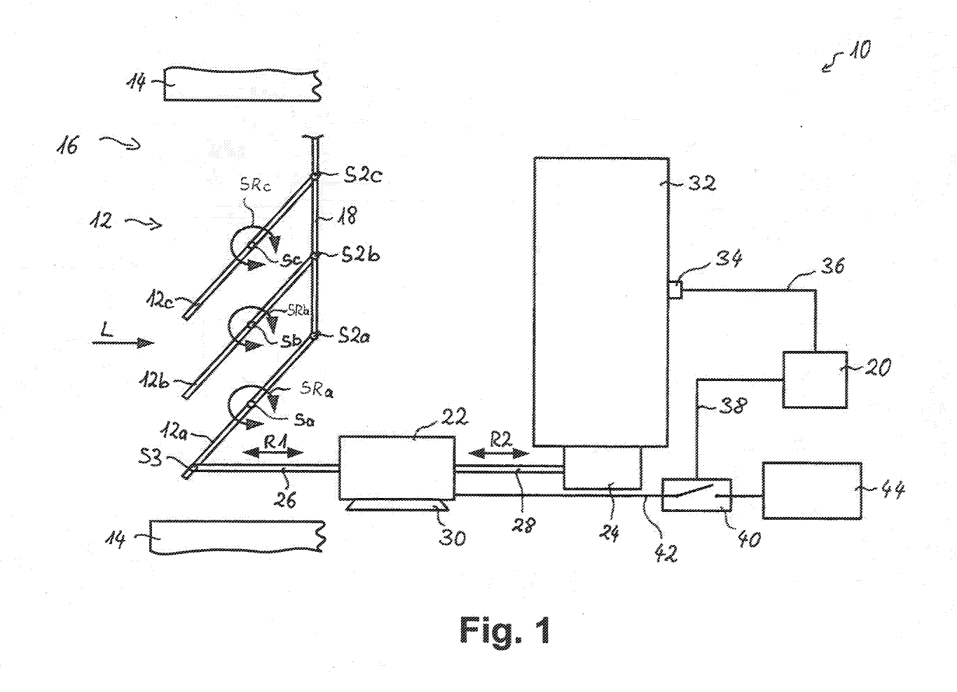

FIG. 1 shows an air flap device designated more generally with 10, which, for example, can be installed in a motor vehicle. It comprises an air flap 12, which can comprise a plurality of lamella-like air flaps 12a, 12b, 12c, which are accommodated swivelable on a housing 14 around respective pivot axes Sa, Sb, Sc in respective swivel directions SRa, SRb, SRc such that by swiveling the air flaps 12a, 12b, 12c, the effective flow cross-section of a flow passage opening 16 defined in the housing 14 can be changed.

Although only three air flaps 12a, 12b, 12c are provided in this embodiment, their number, however, is not limited to three, but one of three different numbers of air flaps can also be provided, for example, only a single air flap. The air flaps 12a, 12b, 12 can each have an area that is smaller than the flow passage opening 16. In that way, in contrast to the case where only a single air flap is provided, whose area essentially corresponds to that of the flow passage opening 16, a more compact design is provided because less free space has to be provided in order to allow the air flaps 12a, 12b, 12c to swivel.

The lamella-liked air flaps 12a, 12b, 12c can be coupled for a mutual adjustment movement by means of a coupling element 18 so that the adjustment of only one of the air flaps 12a, 12b, 12c that are coupled to each other leads to a corresponding adjustment of the other air flaps, which are not directly actuated. As a result of this, there is no need for directly actuating each air flap 12a, 12b, 12c individually.

The air flap device 10 also includes a controllable flap actuator 22 that can be controlled by a control unit 20, as well as an automatic flap actuator 24. As shown in the described embodiment, the controllable flap actuator 22 can comprise a controllable power output part 26 that can be moved in a first power output direction R1. In this case, the controllable power output part 26 can be in a force and movement transferring connection with one of the lamella-like air flaps 12a, and thus be swivelable around a pivot axis S3 relative to the air flap 12a. But it is also basically conceivable that there is no permanent connection between the power output part 26 and the air flap 12a, but that they are only connected to each other during an adjustment movement of the air flap 12a. In such a case, in order to return the air flap 12a to its closing position a pretension element can be provided, which pretensions the air flap 12a in its closing position. This kind of pretension element can, of course, be provided for each air flap 12a, 12b, 12c.

The automatic flap actuator 24 can be provided with an automatic force output part 28 that can be moved along a second power output direction R2. The controllable flap actuator 22 and the automatic flap actuator 24 can, as shown in FIG. 1, be connected in series. In this case, only the controllable power output part 26 of the controllable flap actuator 22 can be connected to an air flap 12a to be adjusted, whereas the automatic power output part 28 of the automatic flap actuator 24 can be connected to the controllable flap actuator 22. In an arrangement of this kind, and for reasons of conservation of the linear momentum, the automatic flap actuator 24 is braced stationary against the housing 14, with the exception of the automatic power output part 28, whereas the controllable flap actuator 22 can, for example, be moved on a slide 30 in the first power-output direction R1 relative to the housing 14. The automatic flap actuator 24 can, for example, be mounted directly on the heat source 32 to be convectively cooled by the inflowing air arranged in the air-flow direction L behind the air flap 12, whereby the flap actuator obtains the energy required for the movement of the automatic power output part 28 from the heat source 32 in the form of heat. The heat source 32 can, for example, be a motor vehicle motor (internal combustion engine) or a fluid heat exchanger.

The heat is transferred from the heat source 32 to the automatic flap actuator 24 via thermal conduction when, as is the case in FIG. 1, there is a direct physical contact between the two. If there is no direct contact between the heat source 32 and the automatic flap actuator 24, the heat is transferred via thermal radiation and convective thermal transfer. It should however be pointed out that even when there is a direct contact, the heat can also be transferred via thermal radiation, even though the heat transfer via thermal conduction is predominant.

The controllable flap actuator 22 is controlled by the control unit 20. This can, for example, take place in accordance with a temperature signal output via a first signal line 36 to the control unit 20 by a temperature sensor 34 mounted on the heat source 32, such that by means of a signal output via a second signal line 38 by the control unit 20 to a switch 40 an energy connection is established or interrupted via an energy connection line 42 between the controllable flap actuator 24 and an energy source 44 that is separate from the heat source 32. The separate energy source 44 can, for example, be a motor vehicle battery or an electric generator, such as, for example, a dynamo.

The automatic flap actuator 24 can comprise an actuator section that deforms when heated and/or undergoes a phase transition. The actuator section can, for example, be configured as a bimetallic strip or as a wax expansion element so that a displacement of the automatic power output part 28 can only be effected when a certain limit temperature, at which the actuator section undergoes, for example, a solid-liquid transition, is exceeded. As a result of this, its volume increases, leading to a displacement of the automatic power output part 28 in the second power output direction R2. In an embodiment of this kind, the lamella-like air flaps 12a, 12b, 12c can only swivel at a temperature below said limit temperature by means of the controllable flap actuator 22. If there is a malfunction, for example, of the controllable flap actuator 22 as such, of the control unit 20, of the temperature sensor 34, of the switch 40, or of the separate energy source 44, and if in that case the effective flow cross-section of the flow passage opening 16 is too small to sufficiently cool the heat source 32, this will inevitably lead to an increase in temperature in the heat source 32. If the temperature of the heat source 32 exceeds the phase transition temperature of the actuator section, the automatic flap actuator 24 will be activated in that the actuator section undergoes a phase transition, its volume thus increasing so that the automatic power output part 28 is moved in the second power output direction R2 in the direction of the controllable flap actuator 22. In this way, a force is exerted on the controllable flap actuator 22 so that the controllable flap actuator 22 is moved on the slide 30 in the first power output direction R1, whereby the lamella-like air flaps 12a, 12b, 12c coupled to each other via the coupling element 18 are swiveled, as a result of which the effective flow cross-section of the flow passage opening 16 is enlarged. In this way, the amount of inflowing fresh air can be increased, which in turn leads to a cooling of the heat source 32.

The phase transition is preferably reversible. Then, a decrease in the temperature of the heat source 32 leads to a reversed phase transition, i.e. for example, a fluid-solid transition, whereby the volume of the actuator section necessarily decreases and the automatic power output part 28 is driven back, possibly under the effect of an additional return spring (not shown). In this way, the controllable flap actuator 22 that is connected to the automatic force output part 28 also moves back on the slide 30, whereby the air flap 12a that is connected to the controllable force output part 26, and, along therewith, also the air flaps 12b and 12c that are connected thereto move to their closing position.

It is also basically conceivable that a selective influence can also be exerted on the temperature of the heat source 32 according to the principle described above with the automatic flap actuator 24 alone. This control, however, evidently only functions within the range of the limit temperature defined by the phase transition so that it is advantageous if the air flap device 10, preferably the controllable flap actuator 22, is configured to send an error message to the control unit 20 in the event of a malfunction in order to detect and remedy a malfunction as early as possible.

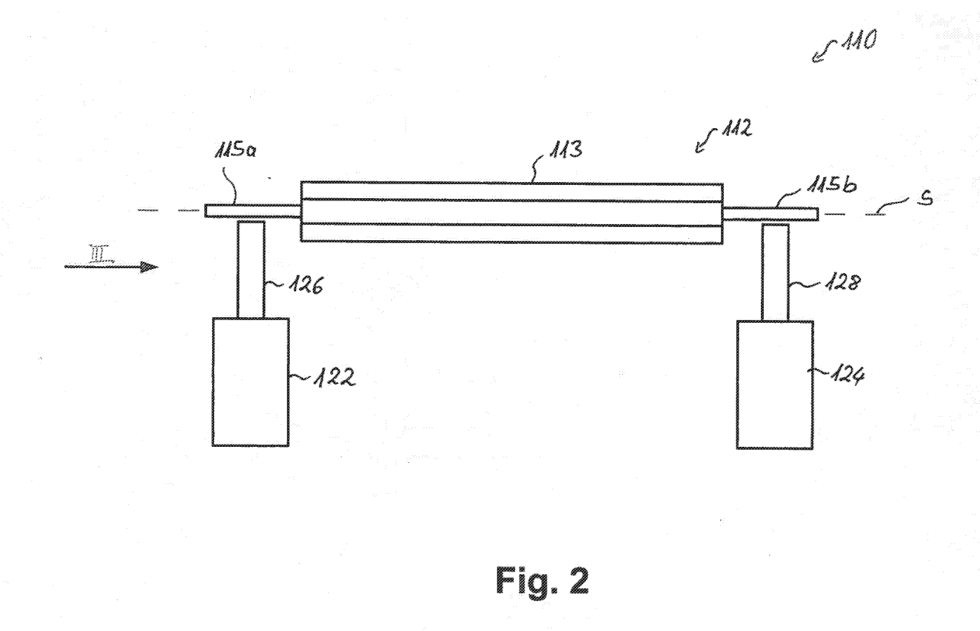

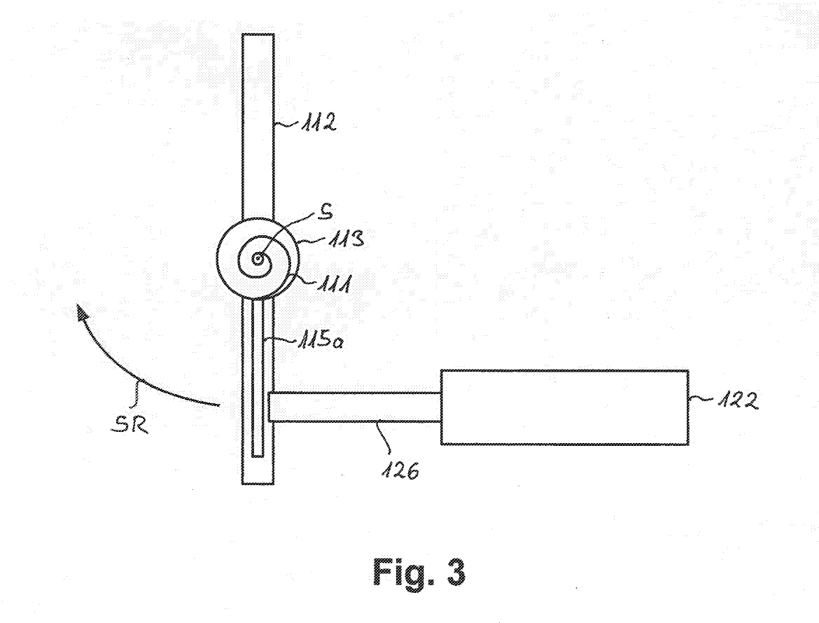

A second embodiment of the present invention will hereinafter be described w reference to the FIGS. 2 and 3, but only to the extent that it differs from the first embodiment, express reference being made in other respects to the description of the first embodiment. In this context, same and functionally identical components will be designated with same reference numerals, increased, however, by the number 100.

FIG. 2 shows a section of an air flap device 110 according to the second embodiment. FIG. 3 shows this section as seen from the direction III in FIG. 2. In contrast to the first embodiment, a controllable flap actuator 122 is connected in parallel to an automatic flap actuator 124. The air flap 112 shown in the figures, which can be swiveled around a pivot axis S in a swivel direction SR, can be provided with a pretension element 111, which can be accommodated in a central section 113 of the air flap 112. The pretension element 11 tensions the air flap 112 in its closing position.

Furthermore, the air flap 112 can feature respective actuation sections 115a, 115b that can be assigned to the controllable power output part 126 of the controllable flap actuator 122, or, as the case may be, to the automatic power output part 128 of the automatic flap actuator 124. In this case, a permanent connection between the respective force output part 126, 128 and the tit corresponding actuation section 115a, 115 does not necessarily have to exist, but it can also be provided that, as in this case, the respective force output parts 126, 128 only contact the respective actuation sections 115a, 115b along the swivel direction SR for an adjustment of the air flap 112, and/or the force output parts 126, 128 only mesh with the actuating section 115a, 115 in one direction in a force transferring manner. This has the advantage that the air flap 112 can only be swiveled by means of one of the two flap actuators 122, 124 independently of the respective other flap actuator.

In other respects, the statements concerning the first embodiment also apply to the second embodiment shown in FIGS. 2 and 3.

1. An air flap device for use in motor vehicles, comprising:
a housing that defines a flow passage opening;
at least one air flap which is accommodated movable on the housing such that by an adjustment of the air flap relative to the housing, the effective flow cross-section of the flow passage opening can be modified;
a heat source arranged in the air-flow direction behind the at least one air flap, an energy source separate from the heat source;
at least one controllable flap actuator that can be controlled by a control unit which has an energizing connection to the separate energy source for adjusting an air flap relative to the housing; and
at least one automatic flap actuator is provided, which is supplied with thermal energy provided directly by the heat source in order to adjust an air flap relative to the housing.

2. The air flap device according to claim 1, wherein said at least one automatic flap actuator can additionally be controlled b the control unit.

3. The air flap device according to claim 2,
wherein the control controls the controllable flap actuator in accordance with the temperature of the heat source detected by a temperature sensor.

4. The air flap device according to claim 1,
wherein said at least one controllable flap actuator is connected in series to at least one automatic flap actuator and/or that at least one controllable flap actuator is connected in parallel to at least one automatic flap actuator.

5. The air flap device according to claim 1,
wherein said at least one automatic flap actuator features an actuator section that is configured to deform when heated, and/or to undergo a phase transition.

6. The air flap device according to claim 1,
wherein at least one automatic flap actuator is configured to cause the adjustment of an air flap only after a limit temperature has been reached.

7. The air flap device according to claim 1,
wherein the heat source comprises a motor vehicle engine and/or a fluid heat exchanger.

8. The air flap device according to claim 7,
wherein the thermal energy of the heat source is transferred by thermal conduction and/or thermal radiation to the at least one automatic flap actuator.

9. The air flap device according to claim 1,
wherein said at least one controllable flap actuator is configured such that in the event of a malfunction, an error message is sent to the control unit.

10. The air flap device according to claim 1,
wherein a plurality of lamella-like air flaps are provided, whereby the area of a single air flap is smaller than the entire area of the flow passage opening.

11. The air flap device according to claim 10, wherein at least some of the air flaps are coupled by means of a coupling element for a common adjustment movement.

12. The air flap device according to claim 1,
wherein at least one air flap comprises a pretension element that pretensions the air flap in the direction of its closing position.

13. The air flap device according to claim 5, wherein said actuator section is configured to deform reversibly when heated.

14. The air flap device according to claim 5, wherein said actuator section is configured to undergo a solid-liquid phase transition when heated.
